(19) United States
(12) Patent Application Publication
(10) Pub. No.: US 2010/0013365 A1
(43) Pub. Date: Jan. 21, 2010

(54) CATHODE STRUCTURE FOR FLAT-PANEL DISPLAY WITH REFOCUSING GATE

(75) Inventors: Pierre Nicolas, Saint Egreve (FR); Jean Dijon, Champagnier (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: Commissariat A L'Energie Atomique, Paris (FR)

(21) Appl. No.: 12/518,661

(22) PCT Filed: Dec. 19, 2007
(86) PCT No.: PCT/EP2007/064195

§ 371 Date: Jun. 11, 2009

(30) Foreign Application Priority Data
Dec. 19, 2006 (FR) 06/55622

(51) Int. Cl. H01J 31/00; H01J 29/46

(52) U.S. Cl. 313/2.1; 313/452; 977/939

(57) ABSTRACT

A cathode structure of triode type which, superimposed over a substrate, includes a cathode electrode, an electric insulating layer, and a gate electrode, the electric insulating layer and the gate electrode having emission openings revealing at least one electron-emitting element electrically connected to the cathode electrode. The structure further includes a refocusing electrode arranged to refocus the electrons extracted by the gate electrode. The refocusing electrode is arranged on the electric insulating layer and is connected to an electric connection allowing a refocusing voltage to be applied to it via electrically conductive nanotubes. The cathode structure can be applied to a matrix-addressed field emission device.

### TECHNICAL AREA

The invention relates to a cathode structure, in particular for a flat panel display with refocusing gate.

### BACKGROUND ART

A display device using cathode luminescence excited by field emission comprises an electron-emitting cathode or structure and an opposite-lying anode coated with a luminescent layer. The anode and cathode are separated by a space in which a vacuum has been set up.

The cathode is either a microtip source, or a source with low threshold field emitting layer. The emitting layer can be a layer of carbon nanotubes, or other carbon-based structures, or containing other materials or multilayers (AlN, BN).

The structure of the cathode can be of diode type or triode type. Document FR-A-2 593 953 (corresponding to American U.S. Pat. No. 4,857,161) discloses a process to fabricate a display device using cathode luminescence excited by field emission. The structure of the cathode is of triode type. The electron-emitting material is deposited on an exposed conductive layer at the bottom of holes made in an insulating layer which carries an electron-extracting gate.

Document FR-A-2 836 279 (corresponding to US patent application 2004/0256969) discloses a triode-type cathode structure for emission display. The cathode structure, superimposed over a substrate, comprises an electrode forming a cathode electrically connected to an electron-emitting material, an electric insulating layer and a gate electrode. An opening made in the gate electrode and an opening made in the electric insulating layer expose the electron-emitting material located in the central part of the gate electrode opening. The openings are slot-shaped and the electron-emitting material, exposed by the slots, consists of elements aligned along a longitudinal axis of the slots.

The electron-emitting material can consist of nanotubes, e.g. carbon nanotubes.

FIG. 1 schematically shows a cross-sectional view of a cathode structure of triode type such as disclosed by document FR-A-2 836 279. Only one emitting element is illustrated in this figure. The structure of the cathode is formed on a substrate 1. Superimposed over the substrate 1, it comprises a cathode 2 carrying a resistive layer 3, an insulating layer 4 and a metal layer 5 forming an electron extracting gate. A slot 6 exposes the resistive layer 3. In the central part of the slot 6, and along the longitudinal axis of the slot, growth pads 7 lie on the resistive layer 3. Only one growth pad can be seen in the figure. The growth pads 7 are in electrically conductive material coated with a catalyst. They allow the growth of nanotubes 8, in carbon for example. Typically, a picture element or pixel comprises a few tens or hundreds of pads arranged in parallel slots.

For emitted current density to be sufficient, the nanotubes must be electrically insulated from the electron-extracting gate, which leads to recessing the gate with respect to the nanotube pads as illustrated FIG. 1.

A field emission flat-panel display comprises gate conductors, generally organized in lines, and cathode conductors generally organized in columns. The picture elements or pixels are formed at the intersection of lines (gate conductors) and columns (cathode conductors), each pixel comprising a few tens or hundreds of electron-emitting elements. For example, one pixel can be formed by the intersection of a line, as shown by the pixel in FIG. 2, and of a column as shown by the pixel in FIG. 3. For better understanding, the gate conductor (line) and cathode conductor (column) are depicted in different figures. It is be understood that the gate and cathode conductors are superimposed so that the slots 11 (see FIG. 2) and 21 (see FIG. 3) of these conductors match as in FIG. 1. Regarding FIGS. 2 and 3, the slots are oriented along the lines of the display, but as a variant it is possible for them to be oriented in the direction of the columns, in accordance with the teaching of document FR-A-2 873 852.

With reference to FIG. 2, a gate (or line) conductor such as gate conductor 10 consists of two parallel strips 12 and 13 regularly linked by zones 14, each zone defining a pixel. Each zone 14 comprises a certain number of slots 11 corresponding to slot 6 in FIG. 1. Inside a gate conductor 10, two successive zones 14 are separated by a free space 15. Between two successive gate conductors 10, there is also a free space 16.

With reference to FIG. 3, a cathode (or column) conductor such as cathode conductor 20 consists of two parallel strips 22 and 23 regularly linked by zones 24, each zone defining a pixel. Each zone 24 comprises a certain number of slots 21 corresponding to slot 6 in FIG. 1.

The electric functioning of the display panel is ensured by time-sequential scanning of the lines (gate conductors). When addressing a given line, a control voltage of the order of 30 to 100 volts is applied to this line, the other lines remaining at ground potential. Modulated voltages of a few tens of volts are jointly applied to the column conductors (cathode) these voltages representing video data to be displayed on this line. The electronic emission of the emitting elements (e.g. the carbon nanotubes) of each pixel of one line is controlled by the difference in potential between the addressed line and the column associated with the pixel under consideration.

This difference in potential, of the order of 80 to 100 volts, sets up an electric field at the end of the nanotubes, and allows electron extraction. The emitted electrons are then accelerated towards an anode coated with luminophores, the anode being brought to a high voltage and located a few millimetres away from the cathode structure. Under the impact of these energy electrons the luminophores emit radiation of red, blue or green colour used to produce monochrome or colour displays.

The resolution of this type of FED display is limited by the size of the optical spot obtained on this anode. For the basic structure of the display just described, this spot size is determined by anode voltage, cathode-anode distance and by initial kinetic energy and initial angle deflection of the electron beam leaving the cathode. Once these parameters have been set taking into account different technological compromises, it is still possible to improve this optical resolution but at the cost of making the structure more complex. In this respect, reference may be made to the article “CNT FEDs for Large Area and HDTV Applications” by E. J. CHI et al., published in SID 05 Digest, pages 1620 to 1623. This complexification, as described in this article, often consists of adding a third metallization layer onto the cathode structure to form a refocusing gate for the beam of emitted electrons. This refocusing gate must be polarized to a potential lower than that of the extraction gate so as to refocus the electrons as soon as they are emitted by the emitting elements (e.g. carbon nanotubes). FIG. 4 illustrates this configuration. It shows a cathode structure formed on a substrate 31. Superimposed over the substrate 31, the structure comprises a cathode conductor 32 carrying a resistive layer 33, a first insulating layer 34, a metal layer 35 forming an electron extraction gate, a second insulating layer 39 and a metal layer 30 (third metallization layer) forming a refocusing gate. A slot 36 exposes the resistive layer 33 which carries growth pads 37 (only one pad can be seen) which allowed growth of the nanotubes 38.

Document US 2006/001359 discloses a cathode structure of triode type which, superimposed over a substrate, comprises a cathode electrode, an electric insulating layer and a gate electrode, the electric insulating layer and the gate electrode having emission openings revealing at least one electron-emitting element electrically linked to the cathode electrode, the structure further comprising a refocusing electrode arranged to refocus the electrons extracted by the gate electrode. The refocusing electrode is arranged on said electric insulating layer and is linked to electric connection means so that a refocusing voltage can be applied to it. The refocusing electrode is polarized at the upper gate metal, which necessarily requires an additional electrode at this level to guide the focusing electrode since this electrode must be polarized at a potential lower than the potential of the gate electrode.

### DESCRIPTION OF THE INVENTION

One objective of the present invention is to propose a cathode structure for flat-panel display having an electron refocusing gate but which does not, as in the prior art, require a second insulating layer carrying a third metallization layer.

The present invention finds particularly advantageous application in a cathode structure for flat-panel display with matrix addressing. Nonetheless, the invention can also be applied to less complex cathode structures, for example cathode structures having at least one electron-emitting element.

The subject of the invention is therefore a cathode structure of triode type which, superimposed over a substrate, comprises a cathode electrode, an electric insulating layer and a gate electrode, the electric insulating layer and the gate electrode having emission openings revealing at least one electron-emitting element electrically linked to the cathode electrode, the structure further comprising a refocusing electrode arranged to refocus the electrons extracted by the gate electrode, the refocusing electrode being arranged on said electric insulating layer and being connected to electric connection means so that a refocusing voltage can be applied to it, characterized in that the refocusing electrode is connected to the electric connection means via electrically conductive nanotubes e.g. carbon nanotubes.

The electric connection means may comprise the cathode electrode.

The electron-emitting element may be electrically connected to the cathode electrode by means of a resistive layer. The electric connection means may comprise a resistive material which may be that of the resistive layer. Advantageously, the nanotubes of the connection means are housed in at least one opening of the electric insulating layer.

The electron-emitting element may consist of nanotubes. Preferably, the nanotubes of the electron-emitting element are carbon nanotubes.

According to one preferred embodiment, the emission openings in the electric insulating layer and in the gate electrode comprise at least one slot-shaped opening in the electric insulating layer associated with a matching slot-shaped opening in the gate electrode. Also preferably, the slot-shaped opening in the electric insulating layer and the matching slot-shaped opening in the gate electrode reveal at least one row of electron-emitting elements aligned in the direction of the slots.

A further subject of the invention is a matrix-addressed field emitter device consisting of a plurality of cathode structures such as defined above, arranged in the form of a matrix array defining lines and columns, the gate electrodes of one same line being grouped together into a gate conductor, the cathode electrodes of one same column being grouped together into a cathode conductor, the intersection between a cathode conductor and a gate conductor defining a picture element or pixel.

The gate conductor and the refocusing electrode may be intermeshed inside a pixel. They may form two interdigitated combs.

Advantageously, the gate conductors have a configuration allowing free spaces to subsist between each pixel and each of its adjacent pixels for distribution therein of the pads of the pixel refocusing electrode.

According to another preferred embodiment, each zone of the refocusing electrode has at least one opening communicating with said at least one opening of the electric insulating layer housing the nanotubes of the connection means, and allowing the nanotubes of the connection means to ensure electric connection with the refocusing electrode.

According to one particular embodiment, each zone of the refocusing electrode has at least one circular opening communicating with said at least one, also circular, opening of the electric insulating layer housing the nanotubes of the connection means. These openings may reveal a plurality of electrically conductive nanotubes occupying the entire space of the openings.

### BRIEF DESCRIPTION OF THE DRAWINGS

The invention will be better understood and other advantages and particular aspects will become apparent on reading the following description given as a non-limiting example and accompanied by the appended drawings among which:

FIG. 1, already described, is a sectional view of a cathode structure of triode type, according to the prior art,

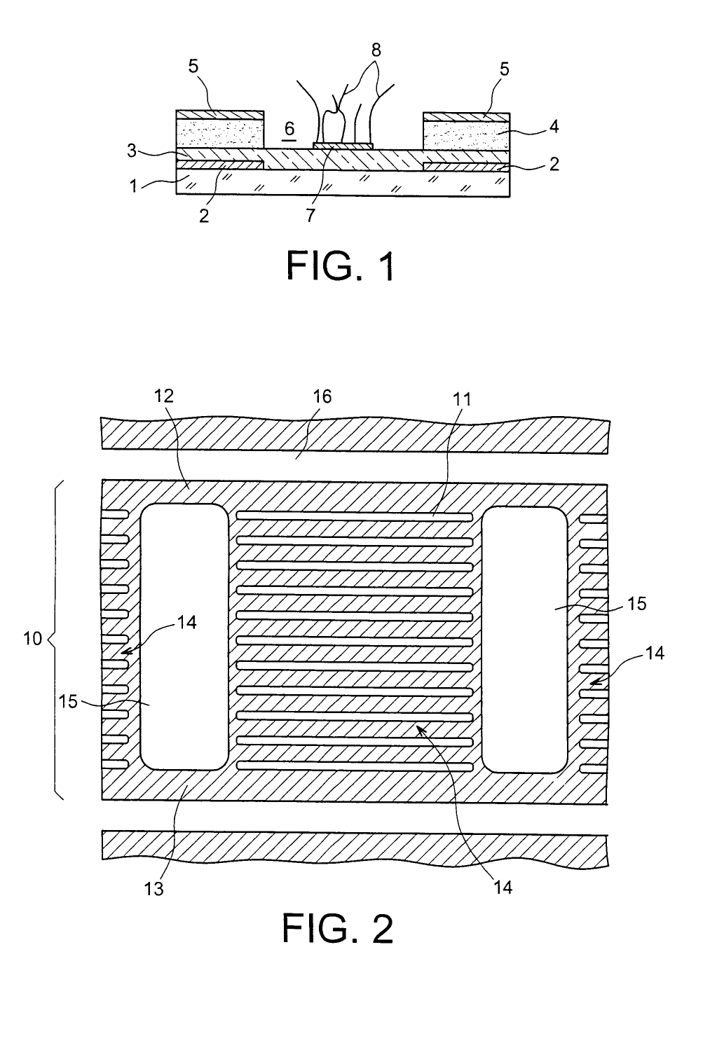

FIGS. 2 and 3, already described, respectively show a gate conductor and a column conductor limited to one single pixel of a flat-panel display according to the prior art,

FIG. 4, already described, is a sectional view of a cathode structure of triode type and with refocusing gate according to the prior art,

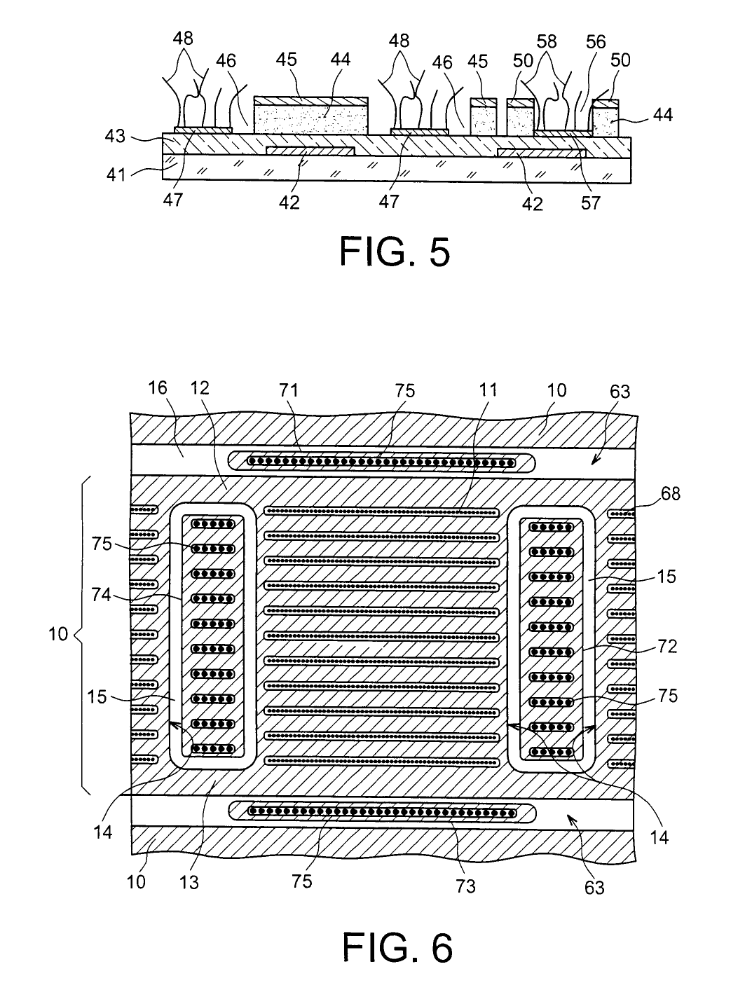

FIG. 5 is a sectional view of a cathode structure of triode type with refocusing gate according to the invention,

FIG. 6 is a partial overhead view of a field emitter device according to the present invention,

FIG. 7 is a partial overhead view of another field emitter device according to the present invention,

FIG. 8 is a magnified view showing another embodiment,

FIGS. 9A to 9G illustrate a first method to fabricate a cathode structure according to the invention,

FIGS. 10A to 10G illustrate a second method to fabricate a cathode structure according to the invention,

FIGS. 11A to 11H illustrate a third method to fabricate a cathode structure according to the invention.

### DETAILED DESCRIPTION OF PARTICULAR EMBODIMENTS

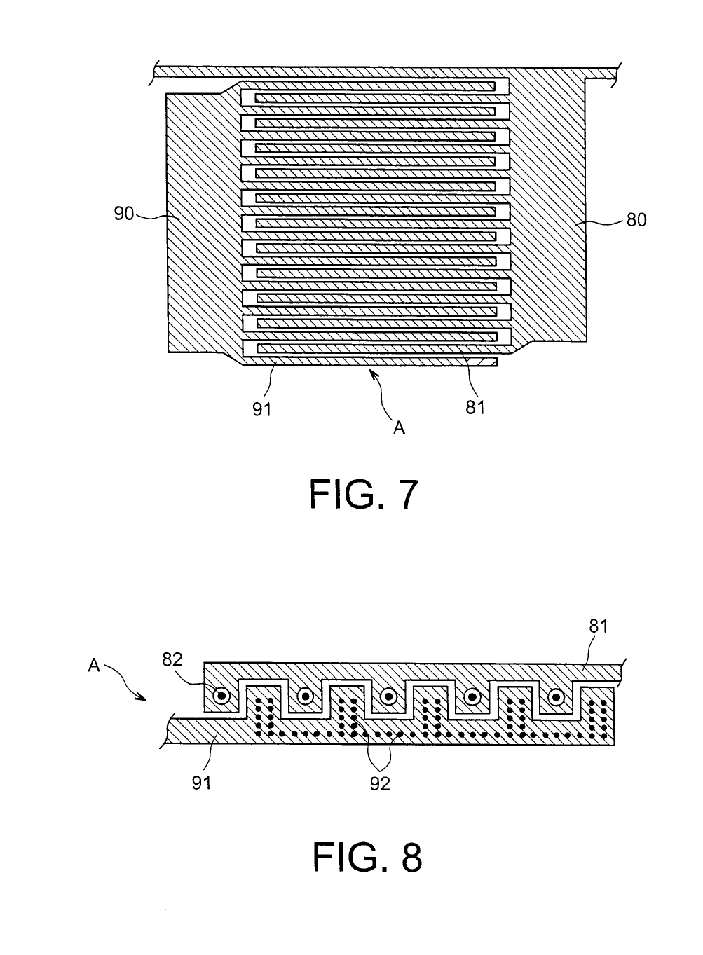

FIG. 5 is a sectional view of a cathode structure of triode type, with a refocusing gate according to the invention. It shows a cathode structure formed on a substrate 41. Superimposed over the substrate 41, the structure comprises a cathode conductor 42 carrying a resistive layer 43, a single insulating layer 44 and a metal layer 45 forming an electron-extracting gate. Slots 46 expose the resistive layer 43 carrying the growth pads 47 which allowed the growth of the nanotubes 48. It is noted that the growth pads 47 are centred in the slots 46 and that there is a certain distance between the growth pads and the edge of the insulating layer carrying the extraction gate 45. This avoids shorting between the nanotubes 48 and the extraction gate 45. FIG. 5, on part of the insulating layer 44, also shows the presence of another metal layer, the metal layer 50 forming the refocusing gate advantageously formed with the same metal level as metal layer 45 forming the extraction gate. An electric connection between the refocusing gate 50 and the resistive layer 43 is ensured by the presence of a growth pad 57 formed at the bottom of an opening 56 made in the insulating layer 44 and by electrically conductive nanotubes 58, advantageously carbon nanotubes which cause a short circuit between the growth pad 57 and the refocusing gate 50. It will be noticed that the growth pad 57 advantageously takes up the entire bottom part of the opening 56 so as to promote short circuits between the nanotubes 58 and the refocusing gate 50.

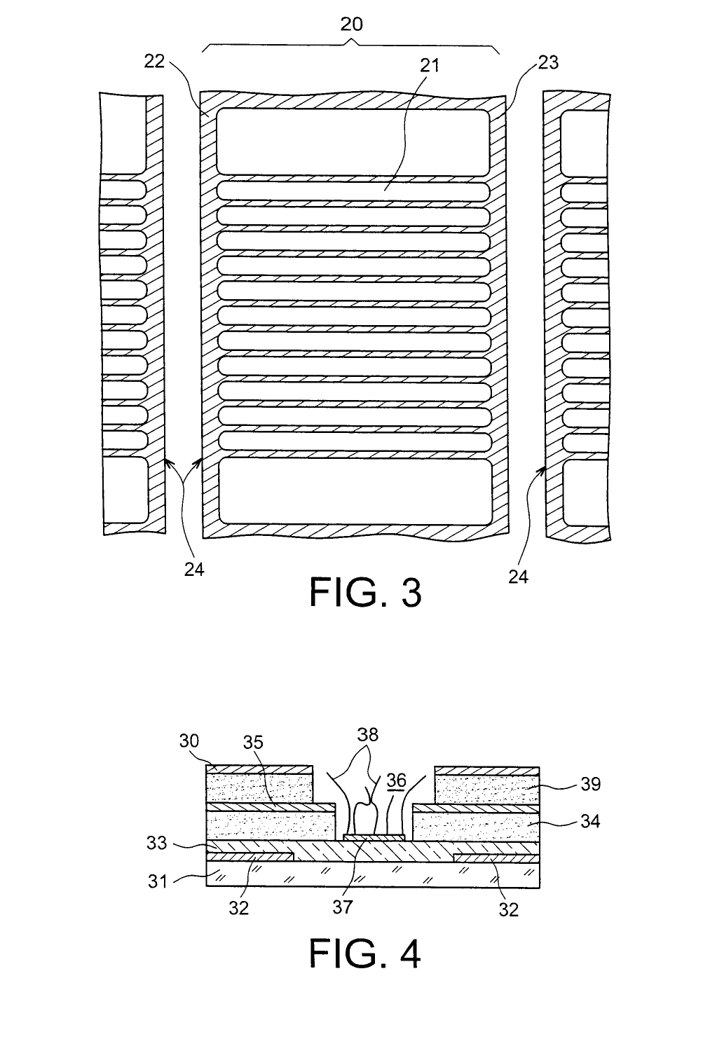

The cathode structure illustrated FIG. 5 is a partial view. To be efficient, the refocusing gate (or self-focusing gate) must, depending on applications, surround an electron-emitting element or a group of electron-emitting elements, for example each group of electron-emitting elements forming a pixel for a flat-panel display. Therefore, if consideration is given to FIG. 2 already described, it is ascertained that, for the pixel shown and the surrounding pixels, there are free spaces 15 and 16 on the insulating layer carrying the gate conductors. These free spaces can receive the refocusing gate of the invention. It is possible, in these free spaces, to define refocusing gate pads provided with slots for example in which the growth pads of carbon nanotubes are deposited. These refocusing gate pads may be practically identical in shape to the electron emission zones defined by the slots shown FIGS. 2 and 3.

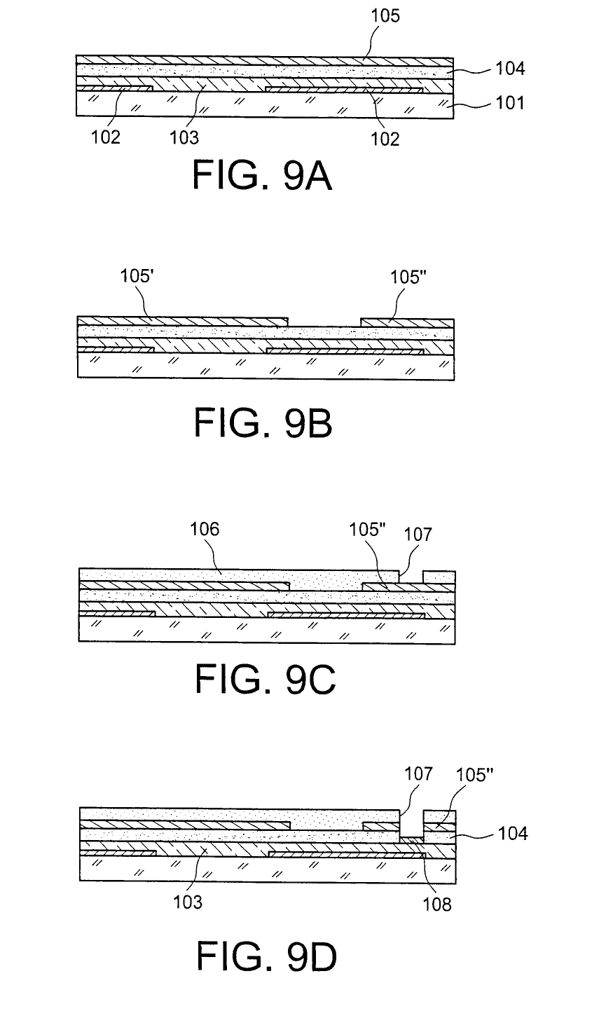

FIG. 6 is a partial overhead view of a field emitter device intended to form a matrix-addressed flat-panel display. This figure shows gate conductors 10 similar to the gate conductor in FIG. 2, carried by an insulating layer 63 and whose slots 11 reveal the electron-emitting elements 68 aligned in the direction of the slots. The slots 11, in FIG. 6, are oriented in the direction of the display lines, but as a variant it is possible for them to be oriented in the direction of the columns of the panel display. The free spaces 15 and 16 form four pads surrounding the pixel 14. Each of these pads comprises part of the refocusing electrode for this pixel. Each of these parts also takes part in the refocusing electrode of its adjacent pixel. FIG. 6 therefore shows four parts 71, 72, 73 and 74 provided with slots whose main axes, in this embodiment, lie in the same direction as the axes of slots 75 made in the gate conductors 10. Other shapes may evidently be envisaged for parts 71, 72, 73 and 74 to maximise short circuits between the nanotubes and the refocusing gate e.g. small, circular openings to the proportion of one opening per growth pad. The slots 75 reveal electron-emitting elements consisting of carbon nanotubes which electrically connect the pads of the refocusing electrode to the cathode conductor whether or not via the resistive layer depending on whether the resistive layer has or has not been previously etched. This refocusing gate will therefore be brought to the potential of the cathode, which will produce the desired effect of refocusing the beam of electrons leaving the central emitting zone. These gate pads will therefore become “self-refocusing” without the addition of a new metal level and without adding a new contact at the lower cathode metal to polarize this refocusing gate. However, this option remains possible at the lower cathode metal. At this lower cathode metal a first sub-assembly of row cathode conductors could be defined as shown FIG. 3, and a second sub-assembly of column conductors electrically insulated from the first sub-assembly. This second sub-assembly of row conductors parallel to the first sub-assembly will have all its columns short-circuited on one same polarization output contact of the refocusing gates. The advantage of this somewhat more complex structure, but in design only, is the ability to control the focusing effect by applying a potential to this new contact that is different from the potential of the cathode columns intended for video. In this case, it is preferable to etch the resistive ballast layer to avoid any consumption in this layer due to the potential difference of the video column conductors and the conductors controlling the refocusing potential.

It will be noted that even if the refocusing gate remains connected to the cathode, the resistive ballast layer 43 could be etched locally at the refocusing gates to promote short-circuiting on the cathode metal. In this case, the growth pads of the connection nanotubes of the refocusing gate are deposited directly on the cathode, and the nanotubes directly interconnect the refocusing gate and the cathode.

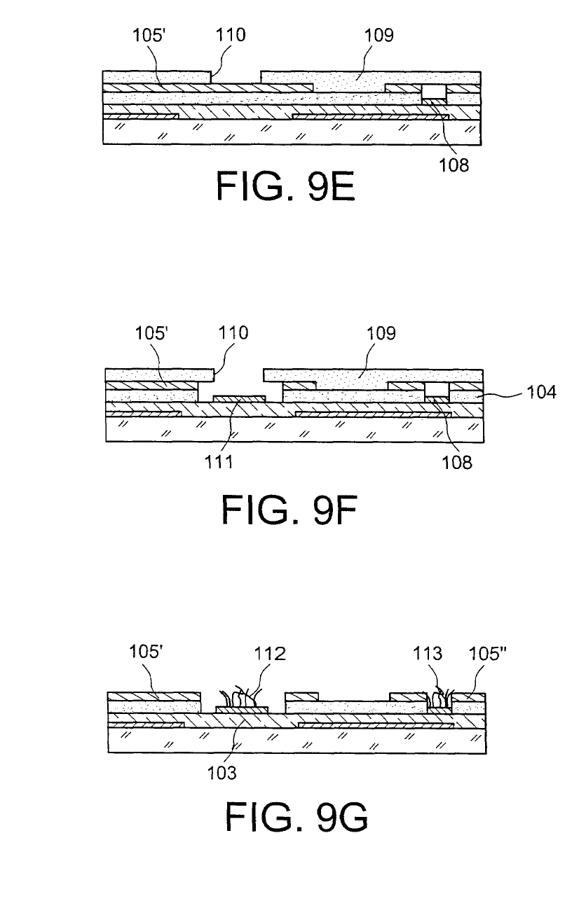

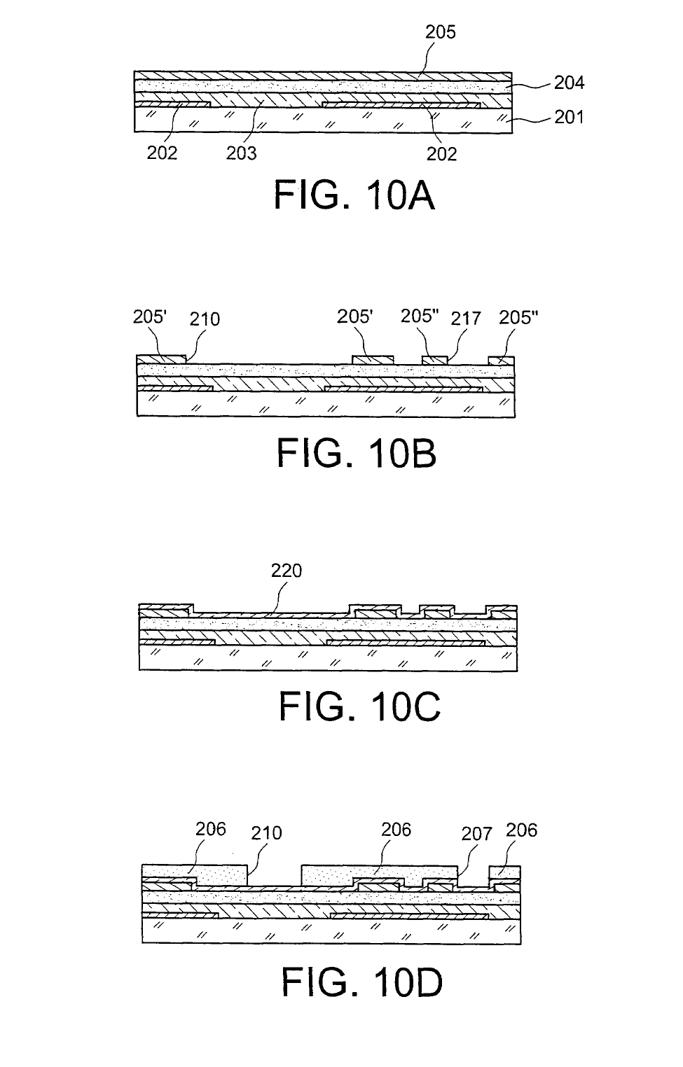

It is also possible to insert these self-refocusing gate zones into the pixel itself, to bring these zones closer to the electron-emitting pads. The geometric proximity will reinforce the focusing field, thereby improving efficacy. Said design, of which one example is given in FIGS. 7 and 8, is to the detriment of the density of the emitting pads and of the current delivered by the pixel. FIG. 7 is an overhead view, at pixel level, of an extraction gate 80 having a series of fingers 81 interdigitated with a series of fingers 91 of an electron-refocusing electrode 90. For reasons of clarity, the openings made in the gates to locate the nanotubes are not shown. Nevertheless, each finger 81 of the extraction gate 80, in its central portion, has one or more openings (advantageously slot-shaped and extending over the entire length of the finger). Similarly, each finger 91 of the refocusing electrode 90 comprises one or more, advantageously circular, openings. In the example shown, focusing will be improved along a vertical axis y having regard to the interdigitation along x of the extraction and focusing “fingers”. To avoid mixing of colours, it is advantageous rather more to improve focusing along axis x, therefore making provision for interdigitation of the “fingers” along y.

If it is desired also to refocus in both directions, the two gates can also be interdigitated along x and y, each gate “finger” then being designed as illustrated FIG. 8. The fingers 81 of the extraction gate have openings 82 through which the electrons pass which are emitted by the electron-emitting elements located in the central portion of the openings 82. Reference 92 represents the openings comprising electric connection means (e.g. carbon nanotubes) short-circuiting the refocusing electrode and occupying the entire opening to maximize shorting. As previously, focusing is improved to the detriment of the density of the emission pads and hence of the current emitted per pixel. To obtain maximum refocusing effect along x or y, each emission pad must be surrounded as much as possible by self-refocusing pads. Since the two gates are located at the same metal level, it is impossible to fully surround the extraction gate by the refocusing gate. There will therefore always remain a direction in which focusing will not be as good e.g. the positive direction along axis y in the enlargement given below. Designing could distribute this direction differently for the different fingers of one same pixel, or for different pixels of one same display panel to average out this effect over the four directions.

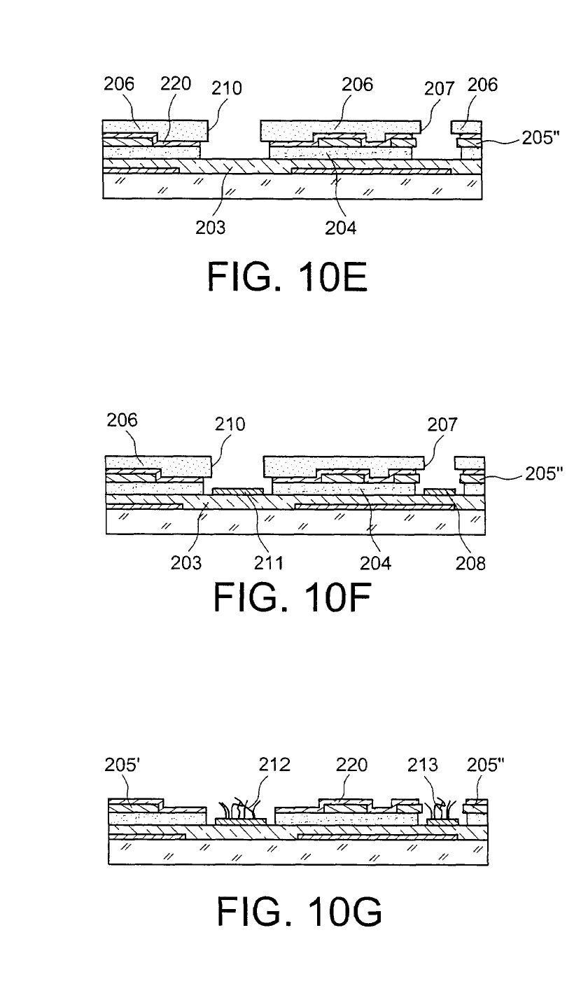

FIGS. 9A to 9G illustrate a first method to produce a cathode structure according to the present invention. For reasons of simplicity, only one emitter is illustrated.

FIG. 9A shows a substrate 101, in glass for example, on which a metal layer has been deposited and etched to form a cathode conductor 102, this metal layer possibly being in molybdenum or a tungsten-titanium alloy, and typically having a possible thickness of 0.1 to a few μm. A resistive layer 103, also called a ballast layer, is then deposited of amorphous silicon for example, having a thickness of between 0.5 μm and 2 μm. On the resistive layer, an insulating layer 104 is deposited e.g. a silica layer of thickness between 1 and 3 μm. On the insulating layer, a conductor layer 105 is deposited, e.g. a layer of molybdenum or copper having a thickness of 0.1 to a few μm. As a variant, it is possible to etch the resistive layer 103 locally at the future growth zone of the nanotubes intended for connection of the refocusing gate.

The conductive layer 105 is then etched to define an extraction gate conductor 105′ and a refocusing electrode 105″ (see FIG. 9B).

A resin layer 106 is deposited on the stack obtained (see FIG. 9C). An opening 107 is made in the resin layer 106, being the size of the growth pad intended for the refocusing electrode and being made until exposure of the refocusing electrode 105″. The diameter of the growth pad can be a few μm if it is circular, or it may have sides of a few μm if it is rectangular or square.

Etching of the opening 107 is continued to extend this opening through the refocusing electrode 105″ and through the insulating layer 104 until the resistive layer 103 is reached. For this purpose dry reactive etching may be used (see FIG. 9D) . At the bottom of the opening 107 and on the resistive layer 103, a catalyst layer 108 is deposited (growth pad) of thickness 1 nm to 20 nm. The catalyst can be iron, nickel, or iron/silicon/palladium/nickel alloys. A metal sub-layer in TiN, TaN, Al or Ti of 50 nm thickness may be provided underneath the catalyst.

The resin layer 106 is removed and a new resin layer 109 is deposited (see FIG. 9E) to allow etching of an opening 110 for the future locating of the electron-emitting element, until the extraction gate conductor 105′ is revealed. The size of the opening 110 is a few μm by a few μm. The resin layer 109 then protects the growth pad 108.

Using wet reactive etching, the extraction gate conductor 105′ and the insulating layer are etched, controlling the recess relative to the opening 110. The catalyst or growth pad 111 is then deposited which may be of the same type as growth pad 108 (see FIG. 9F).

The resin layer 109 is removed and growth of the carbon nanotubes is caused using a CVD process under a pressure of a few tenths mbar acetylene at 550° C. for 1 minute. FIG. 9G shows nanotubes 112 which do not reach the extraction gate conductor 105′, and nanotubes 113 of which some are in electric contact with the refocusing electrode 105″.

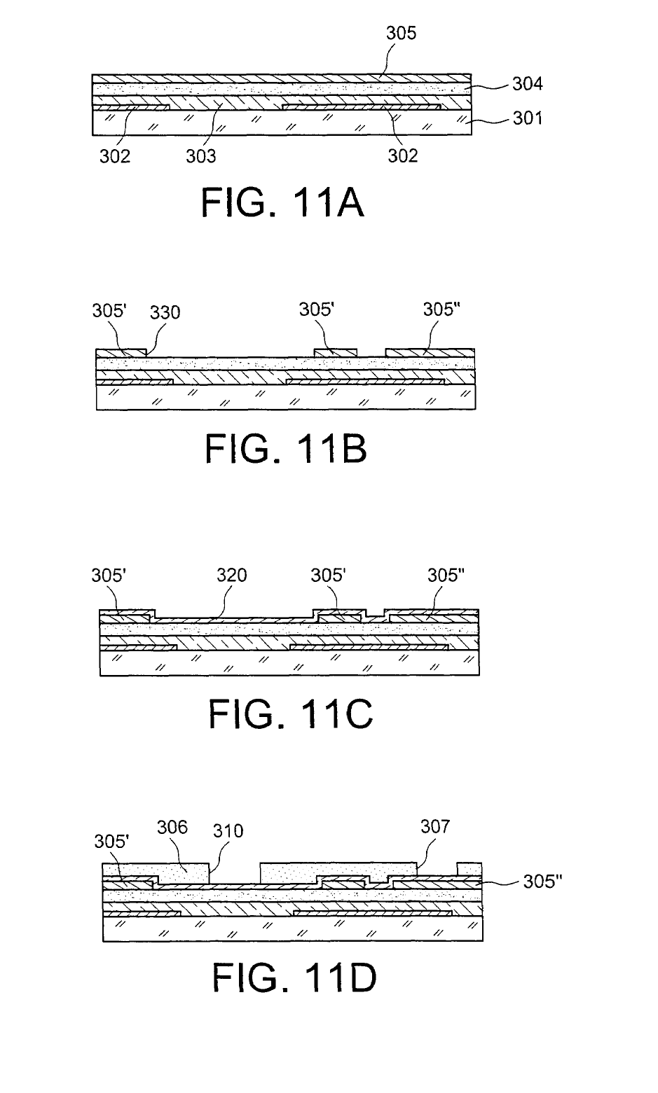

FIGS. 10A to 10G illustrate a second method to produce a cathode structure according to the present invention. For simplification reasons, only one emitting element is illustrated. This second method applies in cases when the extraction gate is coated with a protective resistive layer.

FIG. 10A shows a substrate 201, in glass for example, on which a metal layer has been deposited and etched to form a cathode conductor 202, this metal layer possibly being in molybdenum or a tungsten-titanium alloy and possibly having a thickness of 0.1 to a few μm. A resistive layer 203, also called a ballast layer, is then deposited e.g. a layer of amorphous silicon, with a thickness of between 0.5 μm and 2 μm. On the resistive layer, an insulating layer 204 is deposited e.g. a layer of silica of thickness between 1 and 3 μm. On the insulating layer, a conductive layer 205 is deposited e.g. a layer of molybdenum or copper from 0.1 to a few μm thick.

The conductive layer 205 is then etched to define an extraction gate conductor 205′ and a refocusing electrode 205″ (see FIG. 10B) . Etching is conducted so as also to obtain openings 230 and 217 respectively in the extraction gate conductor 205′ and in the refocusing electrode 205″.

A protective resistive layer 220 is then deposited on the structure previously obtained (see FIG. 10C). This resistive layer 220 may be a layer of highly resistive amorphous silicon or a layer of amorphous carbon called DLC (Diamond Like Carbon). If the resistive layer 220 is in amorphous silicon, its resistivity is at least ten times greater than the resistivity of the ballast layer 203, and its thickness is a few hundred nm so as to obtain resistance that is 100 times greater than the resistance of the ballast layer.

A resin layer 206 is then deposited on the structure obtained previously, and exposure of the growth pad patterns is performed by means of a mask (see FIG. 10D). Openings are obtained in the resin 206, their size being a few um by a few μm: opening 210 centred on opening 230 of the extraction gate conductor 205′, and opening 207 centred on opening 217 of the refocusing electrode. Openings 210 and 207 may be of different sizes in the emission and focusing zones.

Using dry reactive etching, the resistive layer 220 and the insulating layer 204 are then etched to reveal the ballast layer 203 at the bottom of openings 207 and 210 (see FIG. 10E). If necessary, the recessing of the insulating layer 204 and resistive layer 220 are controlled relative to the resin 206 by means of selective wet etching. The metal layer of the refocusing electrode 205″ is not etched with a recess, which will facilitate short-circuiting of the nanotubes on this refocusing electrode “overhang”.

Next, at the bottom of openings 207 and 210 and on the ballast layer 203, catalyst layers (growth pads) are deposited: layer 208 for opening 207 and layer 211 for opening 210. The catalyst may be the one used for the first fabrication method (see FIG. 10F).

The resin layer 206 is removed and growth of the nanotubes is caused using a CVD process, applying a pressure of a few tenths mbar acetylene at 550° C. for 1 minute. FIG. 10G shows the nanotubes 212 which are unable to short-circuit the extraction gate conductor 205′ on account of the protective resistive layer 220. This figure also shows nanotubes 213 of which some are in electric contact with the refocusing electrode 205″.

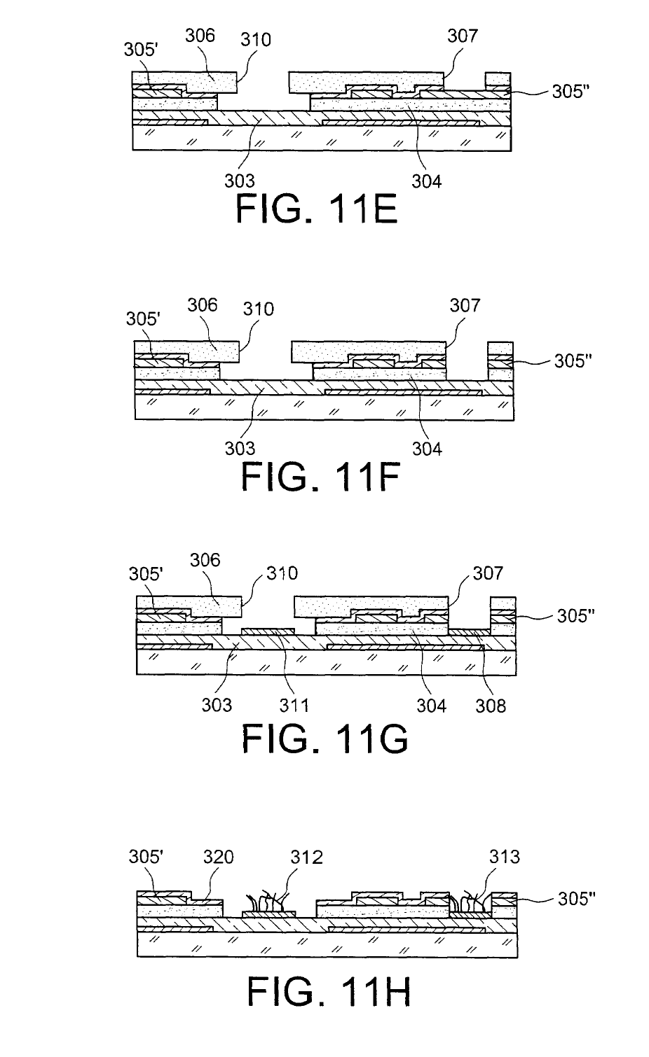

FIGS. 11A to 11H illustrate a third method to fabricate a cathode structure according to the present invention. For reasons of simplification, only one emitting element is illustrated. This third method of fabrication is a variant of the second fabrication method, and allows independent adjusting of the over-etching of the insulating layer between the emitter elements and the electric connection means connecting the ballast layer to the refocusing electrode.

FIG. 11A shows a substrate 301 on which a metal layer has been deposited and etched to form a cathode conductor 302. A resistive layer 303 (ballast layer) is then deposited, followed by an insulating layer 304 and finally a conductive layer 305. These different elements may be identical to those of the second fabrication method.

The conductive layer 305 is then etched to define an extraction gate conductor 305′ and a refocusing electrode 305″ (see FIG. 11B) . Etching is conducted so as also to obtain openings 330 in the extraction gate conductor 305′ but not in the refocusing electrode 305″.

The protective, resistive layer 320 is then deposited on the structure previously obtained (see FIG. 11C) . This resistive layer can be of the same type as that in the second fabrication method.

A resin layer 306 is then deposited on the structure obtained previously and exposure of the growth pad patterns is performed by means of a mask covering the location of the future emission growth pads and electric connection means. Openings are obtained in the resin 306, their size being a few um by a few μm: opening 310 centred on opening 330 of the extraction gate conductor 305′, and opening 307 above the refocusing electrode 305″ (see FIG. 11D). Openings 310 and 307, and hence the growth pads, may be of different sizes in the emission and focusing zones.

Using dry reactive etching, the resistive layer 320 is then etched. From opening 310 etching is continued into the insulating layer 304 until the resistive layer 303 is revealed. The recessing of the insulating layer 304 relative to the resin 306 is controlled by means of wet etching on the insulating layer 304. The refocusing electrode 305″ is used as stop layer for etching in opening 307 (see FIG. 11E).

Next, using dry reactive etching and in the continuation of opening 307, the refocusing electrode 305″ and the insulating layer 304 are etched until the ballast layer 303 is revealed (see FIG. 11F).

At the bottom of openings 307 and 310, on the ballast layer 303, catalyst layers (growth pads) are deposited: layer 308 for opening 307 and layer 311 for opening 310. The catalyst may be the one used for the first and second fabrication methods (see FIG. 11G).

The resin layer 306 is removed and growth of the nanotubes is caused using a CVD process and applying the technique described previously. FIG. 11H shows nanotubes 312 which are unable to short-circuit the extraction gate conductor 305′ on account of the protective resistive layer 320. This figure also shows nanotubes 313 of which some are in electric contact with the refocusing electrode 305″.

1-18. (canceled)

19: A cathode structure of triode type which, superimposed over a substrate, comprises:
a cathode electrode, an electric insulating layer, and a gate electrode, the electric insulating layer and the gate electrode including emission openings revealing at least one electron-emitting element electrically connected to the cathode electrode; and
a refocusing electrode arranged to refocus the electrons extracted by the gate electrode, the refocusing electrode being arranged on the electric insulating layer and being connected to electric connection means allowing a refocusing voltage to be applied to it, wherein the refocusing electrode is connected to the electric connection means via electrically conductive nanotubes.

20: A cathode structure according to claim 19, wherein the electric connection means comprises the cathode electrode.

21: A cathode structure according to claim 20, wherein the electron-emitting element is electrically connected to the cathode electrode by a resistive layer.

22: A cathode structure according to claim 21, wherein the electric connection means comprises a resistive material.

23: A cathode structure according to claim 22, wherein the resistive material is the material of the resistive layer.

24: A cathode structure according to claim 19, wherein the nanotubes of the connection means are housed in at least one opening of the electric insulating layer.

25: A cathode structure according to claim 19, wherein the nanotubes are carbon nanotubes.

26: A cathode structure according to claim 19, wherein the electron-emitting element consists of nanotubes.

27: A cathode structure according to claim 26, wherein the nanotubes of the electron-emitting element are carbon nanotubes.

28: A cathode structure according to claim 19, wherein the emission openings in the electric insulating layer and in the gate electrode comprise at least one slot-shaped opening in the electric insulating layer associated with a matching slot-shaped opening in the gate electrode.

29: A cathode structure according to claim 28, wherein the slot-shaped opening in the electric insulating layer and the matching slot-shaped opening in the gate electrode reveal at least one row of electron-emitting elements aligned in the direction of the slots.

30: A matrix-addressed field emission device comprising:
a plurality of cathode structures according to claim 19, arranged in a matrix array defining lines and columns, the gate electrodes of one same line being grouped together into a gate conductor, the cathode electrodes of one same column being grouped together into a cathode conductor, an intersection between a cathode conductor and a gate conductor defining a picture element or pixel.

31: A device according to claim 30, wherein the gate conductor and the refocusing electrode intermesh inside a pixel.

32: A device according to claim 31, wherein the gate conductor and the refocusing electrode form two interdigitated combs.

33: A device according to claim 30, wherein the gate conductors have a configuration which, between each pixel and each of its adjacent pixels, allows free spaces to exist in which zones of the pixel refocusing electrode can be distributed.

34: A device according to claim 33, wherein the nanotubes of the connection means are housed in at least one opening of the electric insulating layer, and wherein each zone of the refocusing electrode includes at least one opening communicating with the at least one opening in the electric insulating layer housing the nanotubes of the connection means and enabling the nanotubes of the connection means to ensure electric connection with the refocusing electrode.

35: A device according to claim 34, wherein each zone of the refocusing electrode includes at least one circular opening communicating with the at least one, also circular, opening in the electric insulating layer housing the nanotubes of the connection means.

36: A device according to claim 35, wherein the circular openings of at least one zone of the refocusing electrode reveal a plurality of electrically conductive nanotubes occupying the entire space of the openings.
